(19) United States
(12) Patent Application Publication
(10) Pub. No.: US 2005/0028400 A1
(43) Pub. Date: Feb. 10, 2005

(54) Fabric dryer airflow system and method therefor

(76) Inventor: Muir Michael Matteson, Fresno, CA (US)

Correspondence Address: Kent Brian Bathurst;Dowling, Aaron & Keeler, Inc, Suite 200, 6051 North Fresno Street, Fresno, CA, 93710, US

(21) Appl. No.: 10/637,255

(22) Filed: Aug. 9, 2003

(51) Int. Cl. F26B 11/02

(52) U.S. Cl. 34/595

(57) ABSTRACT

A relatively simple fabric drying apparatus achieving high energy efficiency and fast drying at low temperature to be gentle to fabrics. This fabric dryer recirculates air, causing the air to make several passes by the fabrics. Recirculation provides high energy efficiency by ensuring that the air is nearly saturated with water before leaving the dryer; therefore, less energy is wasted heating the air. The present invention's recirculating air is directed upward. Since the flow of recirculating air is directed upward toward the fabrics as they fall downward in the drum, air speed relative to the fabrics is maximized, and the fabrics' fall time increases. Drying time is shortened, because the high air speed past the fabrics means fast water removal; the lengthened fall time of the fabrics also helps speed water removal because the fabric surfaces are more exposed to the drying air while falling.

### CROSS REFERENCE TO RELATED APPLICATIONS

Not Applicable

### STATEMENT REGARDING FEDERALLY SPONSORED RESEARCH OR DEVELOPMENT

Not Applicable

### SEQUENCE LISTING OR PROGRAM

Not Applicable

### DESCRIPTION OF ATTACHED APPENDIX

Not Applicable

### BACKGROUND OF THE INVENTION

1. Field of Invention

This invention relates to fabric dryers, such as those fabric dryers found in homes, laundromats and commercial laundries.

2. Background of the Invention

Fabric dryers are designed to achieve a simple objective: to move air past wet fabric in order to vaporize and carry away the water. A drum is used to tumble the fabrics in order to separate the individual articles so air can pass in between. The air is heated and then passed through perforations in the back or sides of the drum. Inside the drum, the air moves past the clothes, picks up some water from them, then is vented to the outside.

People who own and use fabric dryers seek several qualities in a dryer, most importantly: low initial cost, low operating cost, short drying time, and gentleness to the fabrics.

Regarding drying time: laundromat customers dislike waiting a long time for a fabric dryer to become available. Once a customer finds an available dryer, he or she dislikes waiting an extended time for the fabrics to dry. This is also true for the user of a home fabric dryer. Laundromat owners, for their part, desire short drying times in order to maximize return on investment by accommodating as many customers as possible during any given time.

Major factors affecting the speed of water removal in a fabric dryer are: the relative humidity and temperature of the air moving past the fabric, the speed with which the air moves past the fabric, and the degree of exposure of the fabric surfaces to the drying air.

Relative humidity and temperature of the air as influences on the speed of water removal from fabric in a dryer are thoroughly addressed in the prior art. Temperature is easily addressed in all types of dryer by simply providing a heat source to heat the drying air. Increasing the temperature is an easy way to increase drying speed, but is costly in terms of energy use, and limited by the heat tolerance of the fabrics.

Managing relative humidity is slightly more difficult. The relative humidity inside the dryer quickly reaches saturation if the air is not either dehumidified or replaced. Dehumidification systems are too complex and expensive to adopt for actual use. Replacing the air in the dryer with fresh air from outside is therefore the method used in all relevant prior art; the faster air can be drawn into the dryer from the outside to replace air already in the dryer, the lower the relative humidity inside the dryer will be, and therefore the shorter the drying time. But, the faster the air is brought in from outside, the more energy is needed to heat it, and the more difficult and expensive it is to provide exterior ductwork to supply the air to the dryer and exhaust the air from the dryer. Standard prior art dryers in actual production strike a balance between energy efficiency and drying speed, not excelling in either area. Prior art methods for air recirculation inside the dryer include U.S. Pat. No. 4,665,628, U.S. Pat. No. 5,036,602, U.S. Pat. Pub. No. US 2003/0000104 and U.S. Pat. Pub. No. US 2003/0037460. These prior art references address this problem by recirculating the air back past the fabrics one or more times before the air is exhausted to the outside. This is a step in the right direction, providing both better energy efficiency and shorter drying time than dryers in which the air makes only a single pass.

There remain two other factors that affect drying time: the speed of the air moving past the fabrics, and the degree of exposure of the fabric surfaces to the air inside the dryer. The faster the air moves past the fabrics, the faster the fabrics will dry. Because high air speeds also tend to make the fabrics bunch together, thus reducing the amount of exposed fabric surface presented to the drying air, prior art dryers avoid creating high air speeds. In dryers where the air makes only one pass through the dryer before exiting the system, the airflow is not fast enough to cause fabric bunching, because the amount of air passing through the dryer is limited for reasons discussed herein. In prior art dryers with air recirculation, the airflow moves through the drum either downward, which is undesirable for reasons that will be discussed, or sideways, which causes the fabrics to move toward one end of the drum and bunch up at that end. Therefore, prior art dryers featuring air recirculation must limit the air speed to a level below that which provides maximum drying benefit.

The present invention provides airflow directed upward, the direction which allows maximum air speed past the fabrics without causing bunching. The fabrics in any dryer drum start out bunched in a pile with little surface area exposed. The drum then turns, carrying the fabrics up nearly to the top of the drum's travel; the fabrics then fall back to the bottom of the drum. During this fall, the fabrics are not bunched. Not only are the surfaces of each article separated from each other, the articles become separated from other articles; thus, the fabric surfaces are much more exposed during this part of their travel. Therefore, this is the part of the fabrics' travel where most of the drying is accomplished. This is therefore the part of the fabrics' travel to address the issue of the speed at which air moves past the fabrics. Since the fabrics are moving downward at this point in their travel, the way to move air past the fabrics at the highest relative speed is to blow the air upward in the path of the fabrics' fall. The present invention achieves this.

While upward airflow appears in prior art, such as in the drawing accompanying U.S. Pat. No 6,154,978, and in both the drawing and text of U.S. Pat. No. 4,640,024, these patents disclose only single-pass airflow. As already discussed, the amount of airflow in a single-pass dryer is limited by energy use and duct size issues, so in these prior art dryers, the upward airflow is not fast enough to provide a significant increase in drying speed. The present invention, by using air recirculation, provides a much faster upward airflow, and therefore a large decrease in drying time.

The remaining factor influencing drying time is the degree of exposure of the fabric surfaces inside the dryer. In prior art dryers, the fabrics spend a majority of their time bunched up against the side of the drum as the fabric articles are transported upward. The fabric articles open up as they fall, exposing more surface area to the air. This is a critical phase, because the fabric surfaces need to be exposed to air for the water to be removed from the fabric. In prior art dryers, this maximally exposed phase is over quickly; the fabrics fall, hit the bottom of the drum, and become bunched up again. The present invention lengthens the fall time of the fabrics by blowing air upward at the fabrics, which slows their fall. Thus, they spend more time in the falling phase relative to the bunched-up transport phase. In prior art, for example, U.S. Pat. No. 4,640,024, with its single-pass airflow, does not provide high enough air speed to accomplish this to a significant degree.

By combining the principles of air recirculation (which enhances drying speed by increasing the speed of the air past the fabrics and also provides very high energy efficiency by ensuring that the drying air becomes nearly saturated with water vapor before being exhausted to the outside) with upward airflow (which enhances drying speed by maximizing the speed of the air relative to the fabric articles, and also by maximizing the amount of fabric surface area exposed to the drying air), the present invention dries fabrics very quickly with very high energy efficiency. The present invention dries fabrics so efficiently that the temperature can be dramatically reduced compared to other dryers and still have a reasonably fast drying time. (In a preliminary test, a prototype of the present invention dried towels faster in unheated air at 80 degrees Fahrenheit than a conventional dryer dried the same towels in heated air at 140 degrees Fahrenheit.) Lower drying temperatures are desirable because high temperatures can damage fabrics.

The present invention clearly delivers a major advance in three of the desirable qualities mentioned earlier: low operating cost (because of its high energy efficiency), short drying time, and gentleness to the fabrics.

In regard to the fourth desirable quality, low initial cost, the present invention also excels. The simplicity of the present invention leads to a relatively low manufacturing cost.

Not only do prior art air recirculating systems miss achieving the shortest possible drying time, they are also needlessly complicated. Despite the promise of large benefits in energy efficiency, these systems have not seen wide use. Manufacturers have probably balked at the cost of the major redesigns and high extra production costs that would have been required to adopt them. The present invention can readily be adapted to many existing laundromat and home fabric dryers. Manufacturers will be able to add the present invention's components to the models they currently produce, without having to make major changes. While the present invention will increase the cost of a new dryer, the increase is moderate. The present invention provides such a dramatic improvement in energy efficiency, drying speed and gentleness to fabrics that the relatively small increase in cost will be well worth paying. Therefore, the present invention is more likely to be adopted than current prior art systems.

### BRIEF SUMMARY OF THE INVENTION

The present invention adds a simple component to common fabric dryer systems in current production. It provides added airflow into the dryer drum in a direction nearly opposite to the gravity-induced falling movement of the fabrics inside the drum. This maximizes the speed at which air moves past the fabrics and the time the fabrics spend falling with the fabrics' surfaces exposed, and therefore maximizes the drying speed. Because the added airflow is created by recirculating air within the dryer, the air passes the fabrics multiple times, ensuring that the air has a chance to become saturated with water, therefore providing high energy efficiency. The added airflow inside the dryer is provided by a blower, which recirculates the drying air inside the dryer by blowing the air upward into the drum.

### REFERENCE NUMERALS

Cabinet, 18; air inlet, 20; heat source, 22; perforated drum, 24; direction of drum rotation, 26; recirculating air blower, 30; recirculating air channel, 32; exhaust fan, 34; vane, 36; exhaust plenum, 38; motor shaft, 39; drum pulley, 40; motor pulley, 41; recirculating fan motor, 42; exhaust fan/drum motor, 44; belt, 48; exhaust air outlet, 50; combination recirculating air return and exhaust air collection duct, 52; exhaust air duct, 54; drum with non-perforated sides, 56; combination air recirculating/exhaust blower motor, 58; combination air recirculating/exhaust blower, 60; drum motor, 62.

### BRIEF DESCRIPTION OF THE DRAWINGS

FIG. 1 is a perspective view of one preferred embodiment of the present invention showing air recirculation entering the drum from underneath.

FIG. 2 is a front sectional view of one preferred embodiment of the present invention showing air recirculation entering the drum from underneath.

FIG. 3 is a side sectional view of one preferred embodiment of the present invention showing air recirculation entering the drum from underneath.

FIG. 4 is a perspective view of a second preferred embodiment of the present invention showing air recirculation entering the drum from in front of the lower portion of the drum.

FIG. 5 is a side sectional view of a second preferred embodiment of the present invention showing air recirculation entering the drum from in front of the lower portion of the drum.

FIG. 6 is a sectional view of a second preferred embodiment of the present invention having a tilted drum which encourages the fabric articles to fall toward the recirculated airflow.

### DETAILED DESCRIPTION OF THE DRAWINGS

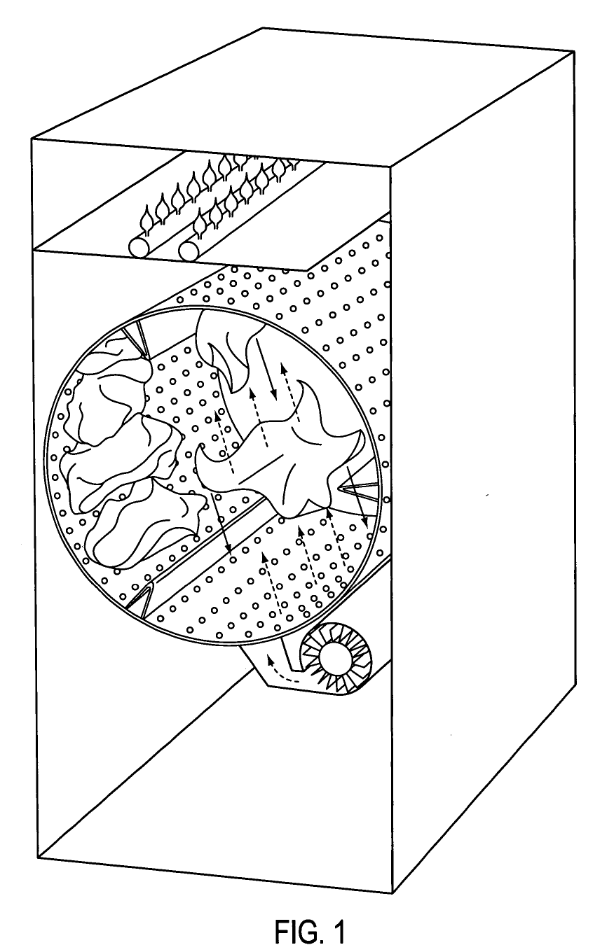

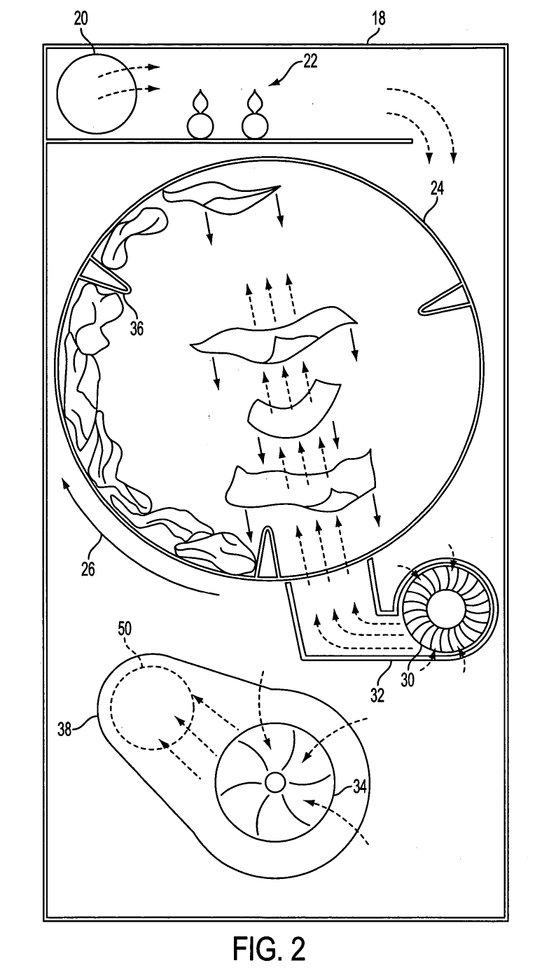

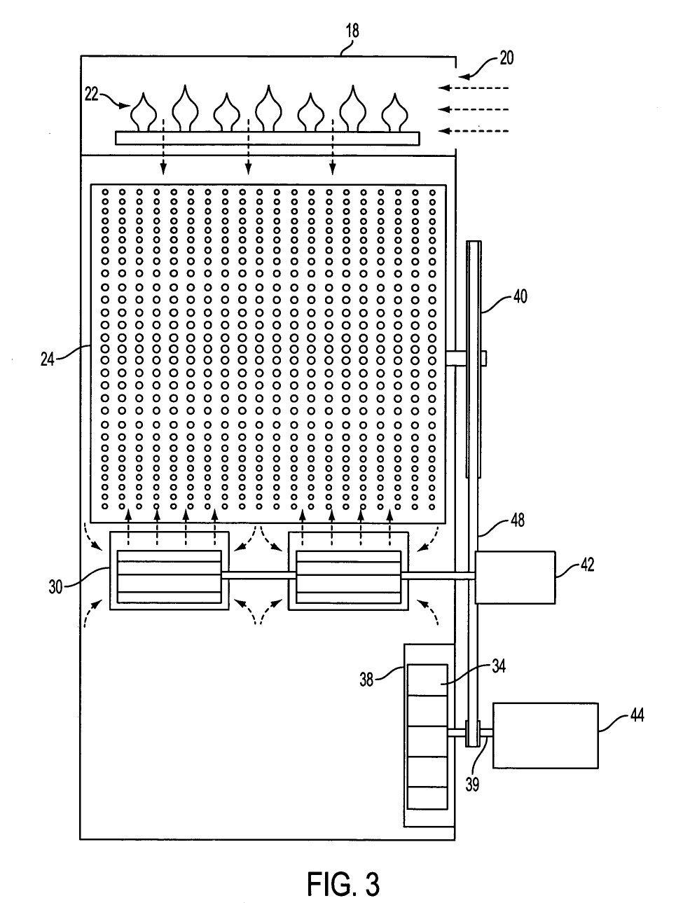

FIGS. 1-3 illustrate one preferred embodiment of the present invention showing air recirculation entering the drum from underneath. FIGS. 1-3 illustrate a dryer comprising a cabinet, 18, inside which is mounted a generally horizontal air-permeable rotating drum, 24. One or more means for preventing or reducing the sliding of the fabric articles inside of the drum, such as vanes, 36, or other suitable means for preventing or reducing the sliding of the fabric articles inside of the drum, are attached to the inside of the drum. An air inlet, 20, provides an entry point for outside air, which can be heated by a heating means, 22, such as a gas flame or other fuel oxidizing reaction, electric heater, steam, heat pump or heat exchanger, or other suitable heating means. The air then passes through the drum. A means for blowing air, 30, such as a blower or a fan or other suitable means for blowing air, recirculates the air, drawing it from outside the drum and blowing it into a recirculating air channel, 32, which is formed and positioned so as to direct recirculated air upward into the drum from the underside of the drum. The recirculating air channel outlet is as close as possible to the drum to minimize air leakage. A means for discharging air from the drum to the outside, 34, such as an exhaust fan, or other suitable means for discharging air from the dryer, sends the air through an air outlet, 50. A means for rotating the drum, 44, such as a motor or other suitable means for rotating the drum, turns the drum; the same means for rotating the drum can also be used to simultaneously rotate the means for discharging air from the drum to the outside and to rotate the means for blowing recirculated air through the recirculating air channel. If desired, a separate means, 42, may be used for powering the recirculating air blower. Those having ordinary skill in the art will readily understand how to transmit power between the specified elements herein using shafts, 39, pulleys, 40, and belts, 48 as illustrated in FIG. 3.

The present invention achieves maximum efficiency when the outlet of the recirculating air channel is located in such a position, and pointed in such a direction, that the air stream from the recirculation blower flows in direct opposition to the motion of the fabric articles during the free fall portion of their travel inside the drum. For example, if the drum rotates clockwise, the recirculated air would enter the drum at about the 5 o'clock position and be directed toward the fabric articles falling from at about the 11 o'clock position. If convenience dictates a different placement, the recirculation air stream may be directed to enter the drum from any position between 3 o'clock and 6 o'clock and still provide benefit. The estimated optimum capacity of the recirculating system should be approximately four or five times the capacity of the exhaust fan. It is also important to note that the recirculating air channel should be fashioned in a way that will prevent objects from falling into the blower blades.

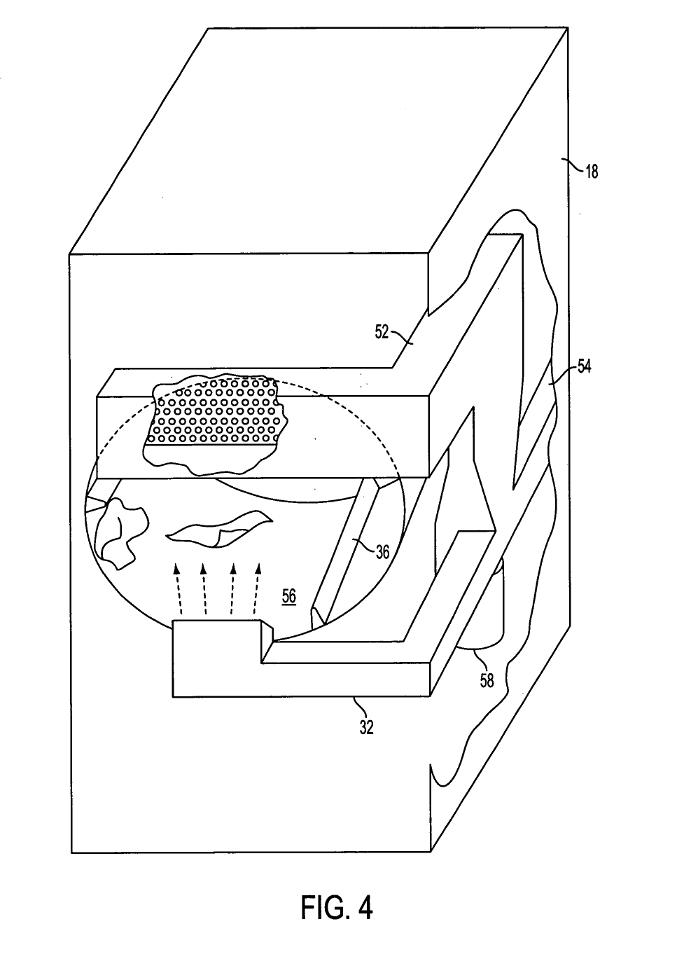

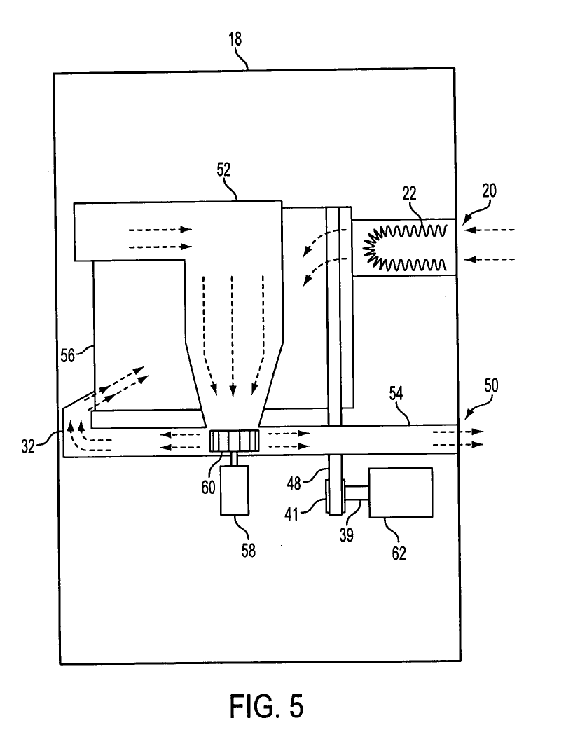

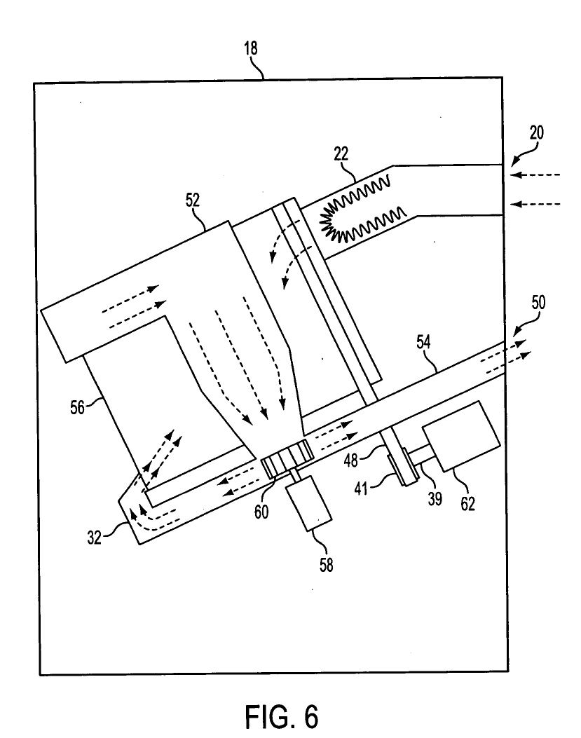

FIGS. 4-6 illustrate a second preferred embodiment of the present invention showing air recirculation entering the drum from in front of the lower portion of the drum. FIGS. 4-6 illustrate a dryer comprising a cabinet, 18, inside which is a rotatably mounted drum with non-perforated sides, 56. Vanes, 36, are attached to the inside of the drum to prevent articles sliding along the inside surface of the drum. An air inlet, 20, provides an entry point for outside air, which is heated by a heating means, 22, and passes through the drum. A combination air return and exhaust air collection duct, 52, collects air from the top and sides of the drum and sends it to a blower or fan, 60. The blower blows some of this air into an exhaust duct, 54, which sends this air to an exhaust outlet, 50. The blower blows the rest of the air into a recirculating air channel or duct, 32. The outlet of this recirculating air channel or duct is positioned in front of the bottom of the drum and pointed upward into the drum, so that the air blowing out of it travels into the drum in a generally upward direction. A motor, 62, turns the drum, with power being transmitted by a belt, 48. Another motor, 42, powers the recirculating blower. In this embodiment, it will be desirable to tilt the drum toward the front so that the fabrics will be encouraged by gravity to fall toward the recirculating air outlet.

Whereas the invention has been shown and described in connection with the preferred embodiments thereof, it will be understood that many modifications, substitutions, and additions may be made which are within the intended broad scope of the following claims. Those skilled in the art will know what materials to use and how to complete the present invention by adding such parts missing from the illustrations such as a door for adding and removing fabric articles, a means for collecting lint, access doors and panels for removing lint and cleaning and servicing the various components, a control system to operate the dryer (including safety devices to prevent overheating or operation with a door or panel open).

1. IMPROVED FABRIC DRYER AIRFLOW SYSTEM AND METHOD THEREFOR comprising:
a means for blowing air upward at one or more falling articles while said articles are inside a generally horizontal air permeable rotating drum.

2. IMPROVED FABRIC DRYER AIRFLOW SYSTEM AND METHOD THEREFOR as claimed in claim 1, wherein said blowing air is directed toward, and in a direction 180 degrees opposite, the general path followed by said falling articles inside said drum.

3. IMPROVED FABRIC DRYER AIRFLOW SYSTEM AND METHOD THEREFOR comprising:
a means for blowing air into a rotating drum in a generally upward direction from in front of the lower portion of said drum.

4. IMPROVED FABRIC DRYER AIRFLOW SYSTEM AND METHOD THEREFOR as claimed in claim 3, wherein said drum is tilted so that the front portion of said drum is lower than the rear portion of said drum so as to cause fabrics to move toward said blowing air.

5. IMPROVED FABRIC DRYER AIRFLOW SYSTEM AND METHOD THEREFOR comprising:
a blower positioned in front of the lower portion of a rotating drum blowing air generally upward into said drum.

6. IMPROVED FABRIC DRYER AIRFLOW SYSTEM AND METHOD THEREFOR comprising:
a cabinet;
a generally horizontal air-permeable drum having a peripheral wall and front and rear walls which are generally perpendicular to the peripheral wall, the front wall having a main opening formed therein, with said drum rotatably mounted within said cabinet;
a means for rotating said drum;
an air inlet to said cabinet;
an air outlet from said cabinet;
a means for discharging air from said drum to the outside through said air outlet;
a recirculating air channel formed and positioned so as to direct recirculated air upward into said drum; and
a means for blowing said recirculated air through said recirculating air channel upward into said drum.

7. IMPROVED FABRIC DRYER AIRFLOW SYSTEM AND METHOD THEREFOR as claimed in claim 6, wherein said drum is made of perforated plastic or perforated metal.

8. IMPROVED FABRIC DRYER AIRFLOW SYSTEM AND METHOD THEREFOR as claimed in claim 6, further comprising a means for heating air before said air exits said recirculating air channel.

9. IMPROVED FABRIC DRYER AIRFLOW SYSTEM AND METHOD THEREFOR therefor as claimed in claim 6, wherein said drum contains one or more means for preventing or reducing the sliding of the contents of said drum along the inside surface of said drum.

10. IMPROVED FABRIC DRYER AIRFLOW SYSTEM AND METHOD THEREFOR comprising:
a cabinet;
a generally horizontal air-permeable drum having a peripheral wall and front and rear walls which are generally perpendicular to the peripheral wall, the front wall having a main opening formed therein with said drum rotatably mounted within said cabinet;
a means for rotating said drum;
an air inlet to said cabinet;
an air outlet from said cabinet;
a recirculating air channel formed and positioned so as to direct recirculated air upward into said drum; and
a means for blowing said recirculated air through said recirculating air channel upward into said drum.

11. IMPROVED FABRIC DRYER AIRFLOW SYSTEM AND METHOD THEREFOR as claimed in claim 10, wherein said drum is made of perforated plastic or metal.

12. IMPROVED FABRIC DRYER AIRFLOW SYSTEM AND METHOD THEREFOR as claimed in claim 10, further comprising a means for heating air before said air exits said recirculating air channel.

13. IMPROVED FABRIC DRYER AIRFLOW SYSTEM AND METHOD THEREFOR as claimed in claim 10, wherein said drum contains one or more means for preventing or reducing the sliding of the contents of said drum along the inside surface of said drum.

14. IMPROVED FABRIC DRYER AIRFLOW SYSTEM AND METHOD THEREFOR comprising:
a cabinet;
a generally horizontal drum having a peripheral wall and front and rear walls which are generally perpendicular to the peripheral wall, the front wall having a main opening formed therein, said drum rotatably mounted within said cabinet;
a means for rotating said drum;
an air inlet to said cabinet;
an air outlet from said cabinet;
a means for discharging air from said drum to the outside through said air outlet;
a recirculating air channel formed and positioned so as to direct recirculated air generally upward into the front of said drum; and a means for blowing said recirculated air through said recirculating air channel.

15. IMPROVED FABRIC DRYER AIRFLOW SYSTEM AND METHOD THEREFOR as claimed in claim 14, wherein said drum is tilted so that the front portion of said drum is lower than the rear portion of said drum so as to cause fabric articles to move toward said recirculated air.

16. IMPROVED FABRIC DRYER AIRFLOW SYSTEM AND METHOD THEREFOR as claimed in claim 14, further comprising a means for heating air before said air exits said recirculating air channel.

17. IMPROVED FABRIC DRYER AIRFLOW SYSTEM AND METHOD THEREFOR as claimed in claim 14, wherein said drum contains one or more means for preventing or reducing the sliding of the contents of said drum along the inside surface of said drum.

18. IMPROVED FABRIC DRYER AIRFLOW SYSTEM AND METHOD THEREFOR comprising:
a cabinet;
a generally horizontal drum having a peripheral wall and front and rear walls which are generally perpendicular to the peripheral wall, the front wall having a main opening formed therein, said drum rotatably mounted within said cabinet;
a means for rotating said drum;
an air inlet to said cabinet;
an air outlet from said cabinet;
a recirculating air channel formed and positioned so as to direct recirculated air generally upward into the front of said drum;
a means for both discharging air from said drum to the outside through said air outlet and for blowing said air through said recirculating air channel to said drum.

19. IMPROVED FABRIC DRYER AIRFLOW SYSTEM AND METHOD THEREFOR as claimed in claim 18, wherein said drum is made of perforated plastic or perforated metal.

20. IMPROVED FABRIC DRYER AIRFLOW SYSTEM AND METHOD THEREFOR as claimed in claim 18, further comprising a means for heating air before said air exits said recirculating air channel.

21. IMPROVED FABRIC DRYER AIRFLOW SYSTEM AND METHOD THEREFOR as claimed in claim 18, wherein said drum contains one or more means for preventing or reducing the sliding of the contents of said drum along the inside surface of said drum.

22. IMPROVED FABRIC DRYER AIRFLOW SYSTEM AND METHOD THEREFOR as claimed in claim 18, wherein said drum is tilted so that the front portion of said drum is lower than the rear portion of said drum so as to cause fabric articles to move toward said recirculated air.

23. IMPROVED FABRIC DRYER AIRFLOW SYSTEM AND METHOD THEREFOR comprising the act of:
blowing air upward at one or more fabric articles while said fabric articles are inside a rotating drum.

24. IMPROVED FABRIC DRYER AIRFLOW SYSTEM AND METHOD THEREFOR of claim 23, further comprising the act of heating said air.

25. IMPROVED FABRIC DRYER AIRFLOW SYSTEM AND METHOD THEREFOR comprising the act of:
causing one or more fabric articles to fall in a direction opposite the direction of blowing air.

26. IMPROVED FABRIC DRYER AIRFLOW SYSTEM AND METHOD THEREFOR of claim 25, further comprising the act of heating said blowing air.

27. IMPROVED FABRIC DRYER AIRFLOW SYSTEM AND METHOD THEREFOR comprising the act of:
blowing air in a generally upward direction from underneath a generally horizontally mounted rotating air-permeable drum into said drum.

28. IMPROVED FABRIC DRYER AIRFLOW SYSTEM AND METHOD THEREFOR of claim 27, further comprising the act of heating said blowing air.

29. IMPROVED FABRIC DRYER AIRFLOW SYSTEM AND METHOD THEREFOR comprising the act of:
blowing air in a generally upward direction from in front of the lower portion of a generally horizontally mounted rotating drum at one or more fabric articles inside said drum.

30. IMPROVED FABRIC DRYER AIRFLOW SYSTEM AND METHOD THEREFOR of claim 29, further comprising the act of tilting said drum so that the front portion of said drum is lower than the rear portion of said drum so as to cause said fabric articles to move toward said blowing air.

31. IMPROVED FABRIC DRYER AIRFLOW SYSTEM AND METHOD THEREFOR of claim 29, further comprising the act of heating said blowing air.

32. IMPROVED FABRIC DRYER AIRFLOW SYSTEM AND METHOD THEREFOR comprising the act of:
blowing air in a generally upward direction at one or more falling fabric articles inside a generally horizontally mounted rotating drum from a channel located in front of the lower portion of said drum.

33. IMPROVED FABRIC DRYER AIRFLOW SYSTEM AND METHOD THEREFOR of claim 32, wherein said blowing air is heated.
